(19) United States
(12) Patent Application Publication
(10) Pub. No.: US 2023/0011577 A1
(43) Pub. Date: Jan. 12, 2023

(54) METHOD AND COMPUTER SYSTEM ADAPTED FOR PERFORMING DIGITAL ASSET DONATION TRANSACTIONS FOR NONPROFIT ORGANIZATIONS

(71) Applicant: Jeffrey G. Conway, Honolulu, HI (US)

(72) Inventor: Jeffrey G. Conway, Honolulu, HI (US)

(21) Appl. No.: 17/373,484

(22) Filed: Jul. 12, 2021

(51) Int. Cl. G06Q 30/02; G06Q 20/36

(52) U.S. Cl. CPC G06Q 30/0279; G06Q 20/3678; G06Q 2220/00

(57) ABSTRACT

In a method and computer system adapted for performing digital asset donation transactions for nonprofit organizations (NPOs), at least one of one or more computing devices ingests digital donation assets from one or more donors intended for a NPO, and then tokenizes the ingested digital donation assets using stablecoin to provide tokenized assets. The tokenized assets are then processed for transfer via ACH to the NPO.

### BACKGROUND

### Field

The example embodiments in general are directed to a method and computer system adapted for performing digital asset donation transactions for nonprofit organizations.

### Related Art

Generally, one of the big promises of blockchain is that it can reduce costs by eliminating or reducing the role of intermediaries. Non-profits and charities are intermediaries, helping to transfer money from donors to people in need. Blockchain technologies could help make them much more effective. Blockchain-based smart contracts, a type of code that self-executes when a certain condition is met, can manage donors' funds more effectively than charities sometimes do, with no overhead and with funds only being released to support specific projects that donors have selected and only when certain conditions or milestones are met.

Alice.si is a network built on the ethereum blockchain that brings together social organizations, donors, grant-makers and impact investors to identify and scale effective social projects. Alice went live in 2017 with its first application, a conditional donation platform that gave donors full transparency on what charities achieve with their money. The first pilot, run by the London-based charity St. Mungo's, helped 15 homeless individuals in London find homes and deal with mental health and addiction issues.

Platforms such as Alice even make sure donors can redirect their funds to other causes if the charity fails to meet the promised milestones. While Alice uses blockchain technology to manage donations, givers can contribute in fiat currency.

Some charities—RED CROSS®, SAVE THE CHILDREN®, UNITED WAY®, the WIKIMEDIA® Foundation, and the ELECTRONIC FRONTIER™ FOUNDATION, to name a few—accept donations in cryptocurrency. So does FIDELITY CHARITABLE®. The 501(c)(3) associated with the brokerage FIDELITY INVESTMENTS® received cryptocurrency donations totaling $69 million in 2017.

Because the IRS categorizes cryptocurrencies as assets, both charities and donors get a major benefit from donating bitcoin. Investors save on capital gains taxes by donating appreciated assets directly. Charities receive the full value of the assets since they are exempt from paying capital gains taxes.

FIG. 1 is an example of a prior art network which utilizes blockchain for donations. Namely, FIG. 1 is a block diagram for illustrating a prior art digital private health care network for giving/donating between donors, healthcare providers, individuals in need, and non-profit organizations (NPOs). In FIG. 1, a donor 201 donates money to be directed to a non-profit organization or an individual. A private, distributed healthcare network 202 processes the donation and one or more of the following steps occurs. Namely, a non-profit organization (NPO) 203 receives donated money, or an individual 204 in need receives donated money, or a healthcare provider 205 receives donated money, or a crowdsourced fund 206 donates money to a Non-profit organization or to an individual, or corporate organizations 207 donate money to the private healthcare network.

FIG. 2 shows interconnected elements of the prior art private distributed ledger network 202. These include a donation ledger 301, a token ledger 302, a distribution engine 303 and a reconciliation engine 304, which is a program that verifies block chain ledger integrity. To run the digital private health care network 202 and funding accounts, an organization (healthcare entity) is needed to keep track of funds. The healthcare entity is responsible for controlling and maintain the funding accounts and assuring that funds meet accounting standards. To transfer money, a corporate bank account can be set up to process transactions and monitor payments to providers. Standard payments may be made by wire transfer or by check.

Donors can access the healthcare network through a dedicated interface program, or through a website page on the Internet. All donor donations are recorded in a donation ledger 301 in a token donation currency. The donated money is converted to cash tokens and assigned to the NPO or individual to whom the donation is made. Conversions and assignments are performed using features available with blockchain technologies.

A fund payout system within distribution engine 303 converts tokens to cash and then issues the cash to the healthcare provider as directed by the donor. As an example, an NPO is able to donate NPO tokens to individuals who are in need of help. Individuals who receive cash tokens can obtain services (such as a healthcare provider) and pay any balance due in tokens. The cash tokens effectively pay a merchant equivalent money. Where a merchant cannot accept tokens, the individual can submit the bills to the private distributed ledger network 202, which in turn pays cash to the merchant. A NPO is never given money, and the private distributed ledger network 202 tracks movement of tokens and payouts to provide full transparency. Using blockchain transaction verification capabilities, the private distributed ledger network 202 can have one or more independent organization(s) validate all transactions. The reconciliation engine 304 reconciles the money and token ledgers. The reconciliation engine 304 is implemented in connection with the distribution engine 303 and the two ledgers 301, 302.

To facilitate financial accountability, a private block chain ledger (donation and token ledgers 301, 302) is created for each health care funding account, and is designed to be tamper proof and provide accountability to the flow of cash (donations—gifts—tips) to a final destination where the cash is spent at a healthcare provider. The ledger is set up to provide limited access to donors and patients, and is a permanent record (i.e. cannot be deleted).

The use of a private block chain ensures data integrity and transparency of cash flow. The patient and donor are given access/ID codes which are used to verify how the money is spent. A small transaction fee (1-5%) is assessed to log transactions, administer the member system, and support long term sustainability.

The donation itself is a peer-to-peer transaction within the private distributed ledger network 202. The network 202 requires that the donated money is used for health care purposes. To this end, healthcare providers join the private distributed ledger network 202, and are verified as healthcare providers.

The blockchain is a continuously growing list of fund records, called blocks, which are linked and secured by cryptography. Each block refers to the previous block in a transaction chain. It is an open, distributed ledger that records transactions between two accounts in a verifiable and permanent way. The private distributed ledger network 202 requires registration where an individual or company is validated by a network administrator using a set of rules. The blockchain is essentially a permissioned network. This places restrictions on who is allowed to participate in the network 202, and how certain transactions are made. Members and donors need to register and be validated to join. Once a member/donor/company has joined the network 202, they play a role in maintaining the blockchain in a decentralized manner.

NPOs routinely have multiple credit card processors for web and app donations (FACEBOOK®, INSTAGRAM®, etc.). These credit card processing companies/gateway providers usually charge 2.5%-3% fees per transaction to process credit cards. Managing multiple payment vendor agreements consumes valuable administrative time and financial resources required to manage NPO or charity operations on a day-to-day basis.

NPOs and charities rely on other providers like banks to process check donations. But few nonprofits have the ability to accept cryptocurrency payments due to self-imposed cryptocurrency holding limitations. To date, there is no known blockchain-based nonprofit exchange which offers the following range of service offerings: (a) credit card processing, such as IATS® Payments, CHARITYENGINE®, BRAINTREE®, VANTIV®, HEARTLAND® Payment Systems, WORLDPAY®, and COSTCO® Payment Processing; (b) check/e-check processing, such as that offers by DUE®, ACH DIRECT®, ACH PAYMENTS®; and (c) cryptocurrency payment processing, such as that offered by BITPAY® (flat 1% fee). Further, there is no particular blockchain-based exchange which (d) processes major gift donations, where the gift is a transfer of securities. In other words, NPOs lack a centralized capability to process major gift donations in the form of securities.

There remains some institutional resistance to technology adoption, in that many nonprofits believe they can do it on their own (not broken so no need to fix it). As challenges grow, NPOs also need to grow. Transparency and trust remain the keys to success, and people want to be involved in the work of an NPO. The demand for programs and services is rising in an increasingly volatile world; case in point, in the SALESFORCE® Nonprofit Trends Report—Second Edition, over 75% of nonprofits reported an increase in demand for programs, and 74% of NPOs reported that their constituents' desire to participate in their organization's work has increased over the last five years. Further, 69% of nonprofits say the demand for transparency regarding funding has increased.

Existing and new technology may be another key to success, but challenges remain. Although technology helps connect nonprofits with their constituents, NPOs lack IT talent, vision, and budget; accordingly capturing and leveraging data are continuous challenges for NPOs. Additionally, 93% of NPOs in the report stated that the lack of IT or technical staff is a challenge to their organization's adoption of new technologies. Further, 85% of nonprofits surveyed said technology is the key to the success of their organizations, but about 75% of respondents noted that how to measure and report data presents a challenge.

Given the inherent advantages of blockchain to charities and NPOs, the full capabilities of the technology still remain underutilized today. What is needed is a cloud-based, dedicated non-profit blockchain exchange system that tokenizes donations using stablecoin for processing and transference of payments to NPOs and charities. Moreover, a system and methodology which is able to make the stablecoin traceable to ensure transparency and exploit the use thereof in a blockchain platform is needed to backstop the tokenizing of those donations using stablecoin to effect payment to NPOs, charities, and the like.

### SUMMARY

An example embodiment of the present invention is directed to a method executed by one or more computing devices for performing digital asset donation transactions for nonprofit organizations (NPOs). In the method, at least one of the one or more computing devices ingests digital donation assets from one or more donors intended for a NPO, and then tokenizes the ingested digital donation assets to provide tokenized assets. The tokenized assets are then processed for transfer via ACH to the NPO.

Another example embodiment is directed to a computer system adapted for performing digital asset donation transactions for nonprofit organizations (NPOs), where the system includes a processing hardware set, and a computer-readable storage device medium. The processing hardware set is structured, connected and/or programmed to run program instructions stored on the computer-readable storage medium instructions and associated data, the program instructions including: an ingestion module programmed to ingest digital donation assets from one or more donors intended for a NPO, a tokenization module programmed to tokenize the ingested digital donation assets to provide tokenized assets, a database for storing unique identifiers associated with the tokenized assets, and a processing module programmed to process the tokenized assets for transfer via automated clearinghouse (ACH) to the NPO.

Another example embodiment is directed to a computer system adapted for performing digital asset donation transactions for nonprofit organizations (NPOs), where the system includes a processing hardware set, and a computer-readable storage device medium. The processing hardware set is structured, connected and/or programmed to run program instructions stored on the computer-readable storage medium instructions and associated data, the program instructions including: a payment API configured to accept a cryptocurrency donation asset using encryption techniques that regulate the generation of units of currency and verify the transfer thereof, the API operating independently of a central bank, a tokenization module programmed to tokenize the cryptocurrency donation asset using stablecoin to provide tokenized assets, a database for storing unique identifiers associated with the tokenized assets, and a processing module programmed to process the tokenized assets for transfer to the NPO.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a block diagram for illustrating a prior art digital private health care network for giving/donating between donors, healthcare providers, individuals in need, and non-profit organizations (NPOs).

FIG. 2 a block diagram to show interconnected elements in the prior art private distributed ledger network of FIG. 1.

FIG. 3 is a general block diagram to illustrate the process flow for a method of performing digital asset donation transactions for nonprofit organizations, and the blockchain exchange system adapted to execute the method, according to the example embodiments.

FIG. 4 is a flowchart to describe the method of performing digital asset donation transactions for nonprofit organizations in more detail, according to the example embodiments.

FIG. 5 is a block diagram of an exemplary computer system and/or computing device of the blockchain-based exchange for implementing the example method.

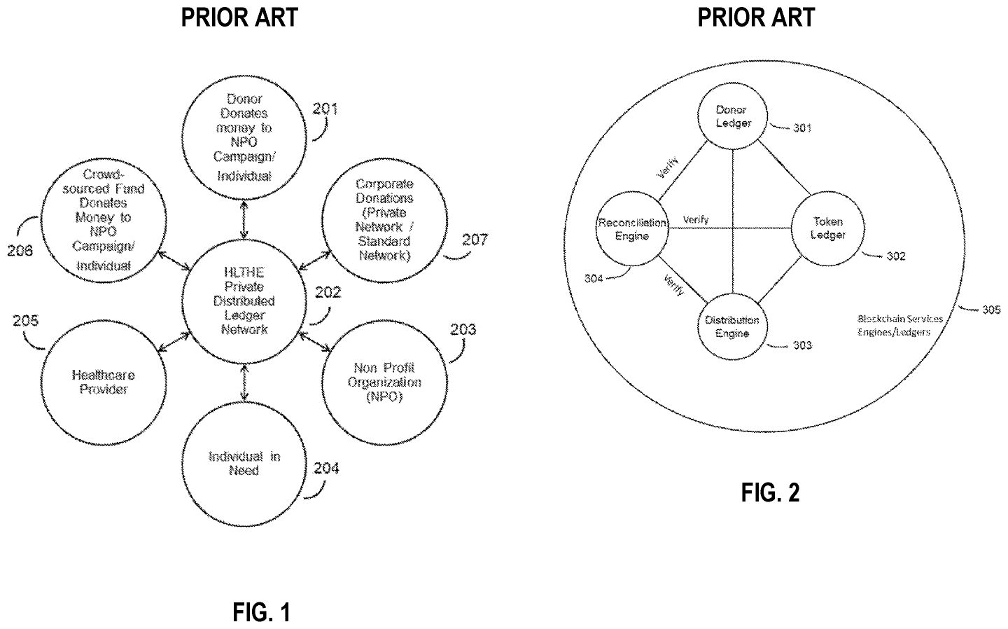

### DETAILED DESCRIPTION

Accordingly, as to be described in more detail hereafter, there is described a method for performing digital asset donation transactions for nonprofit organizations, and a nonprofit exchange that executed the method through the tokenization of donations using stablecoin for processing and transference of payments to NPOs and charities.

As discussed above, NPOs are using technology, but adoption and success vary. The largest focus for NPO marketing is digital outreach, and fundraising teams have the highest adoption of basic CRM. However, program teams lag behind other NPO departments in the adoption of technology; although 91% of NPOs have a core CRM or are planning to use one, less than one third of development teams use mobile technologies for staff or constituent experience. Additionally, according to the SALESFORCE report, 85% use insights from their marketing and engagement data to target outreach, where social media, website, and advertising represent the top three focus areas. Further, 85% of the responding NPOs held a belief that technology can replace much of the manual tasks that take them away from delivering services.

As to be shown in detail hereafter, and to address some of the above concerns, the exemplary method and nonprofit exchange system serve as a single source provider for all nonprofit organization (NPO) payment needs, to include credit card processing, e-check, cryptocurrency, and major gift donations. The example nonprofit exchange provides the capability for donors to make donations directly through the blockchain-based nonprofit exchange to registered nonprofits. The nonprofit exchange in one example may be embodied as a blockchain-based cloud hosted platform, and is a PCI DSS Level 1 certified platform. Further, the example blockchain-based nonprofit exchange system can be integrated with nonprofit event management software, as well as with apps like FACEBOOK and INSTAGRAM.

In general, the exemplary method and system tokenizes ingested donations processed therethrough using stablecoin pegged, in one example, to the US dollar. Effectively, every stablecoin equals one US dollar. The example system may be configured to accept cryptocurrency payments in the form of bitcoin, ripple, ethereum, and the like. Cryptocurrency payments are instantly settled upon donation using the current cryptocurrency market rate.

The nonprofit exchange system detailed hereafter targets the following markets by offering solutions for NPO payments and finance, nonprofit event management software integration, and may enhance corporate giving technologies. Additionally as to be shown hereafter, the exemplary method and system offers NPOs the capability to transfer stablecoin-backed donations to/from affiliated chapters, either at the national or subchapter level. The system permits national nonprofits and subchapters to establish a “tax” percentage of each donation that goes to national level resources. Many national NPOs rely on subchapter donations to fund operations.

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

As used herein. “blockchain” can be understood as a system in which a record of transactions made in bitcoin or another cryptocurrency are maintained across several computers that are linked in a peer-to-peer network. At its most basic level, blockchain is literally just a chain of blocks, digital information (the “block”) stored in a public database (the “chain”).

“Blocks” on the blockchain are made up of digital pieces of information. Specifically, a block consists of three parts: (1) a first part which stores information about transactions like the date, time, and dollar amount of recent transactions or purchases; (2) a second part which stores information about who is participating in transactions; e.g., the seller (“AMAZON®”) and the purchaser, where the actual purchase is recorded without any identifying purchaser information using a unique digital signature, etc.; and (3) a third part which stores information that distinguishes the block from other blocks. Each block stores a unique code called a “hash” that allows one to tell it apart from every other block. Hashes are cryptographic codes created by special algorithms, so even when purchasing the same item twice, although the details of the second transaction would look nearly identical to the original purchase, the blocks can be identified apart from one another because of their unique codes. A single block on the bitcoin blockchain can store up to 1 MB of data. So depending on the size of the transaction(s), a single block could house a few thousand transactions under one roof.

As used herein, an “API” is an application programming interface, a system of protocols designed for accessing computing resources. As used herein “PCI DSS” stands for the Payment Card Industry Data Security Standard, a set of industry standards for credit card processors. PCI DSS level compliance is required in order to accept credit card payments. Namely, PCI DSS Level 1 is a set of requirements to ensure that companies who store, transmit, or process credit card data do so to the highest standards. PCI DSS Level 1 is the highest level of compliance. This describes any merchant processing over 6 million credit card transactions per year.

Additionally as used herein, a “token” is a unit value that exists on an existing blockchain. Tokens do not have their own blockchain, but depend or exist on an existing blockchain of a cryptocurrency. e.g., ethereum, bitcoin etc. As a token has a unit value, that value is tradable. The value can be in the form of coins, points, certificated, in-game items etc.

Further, and as used herein, a “stablecoin” is a cryptocurrency designed to minimize the volatility of the price of the stablecoin, relative to some “stable” asset or basket of assets. A stablecoin can be pegged to a cryptocurrency, fiat money, or to exchange-traded commodities (such as precious metals or industrial metals).

As used herein, the terms “program” or “software” are employed in a generic sense to refer to any type of computer code or set of computer-executable instructions that can be employed to program a computer or other processor to implement various aspects of the present invention as discussed above. Additionally, it should be appreciated that one or more computer programs that when executed perform methods of the example embodiments need not reside on a single computer or processor, but may be distributed in a modular fashion amongst a number of different computers or processors to implement various aspects of the example embodiments.

Computer-executable instructions may be in many forms, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

Additionally, a “computer system” or “computing device” as used hereafter encompasses any of a smart device, a firewall, a router, and a network such as a LAN/WAN. As used herein, a “smart device” or “smart electronic device” is an electronic device, generally connected to other devices or networks via different wireless protocols such as Bluetooth, NFC, WiFi, 3G, 4G, etc., that can operate to some extent interactively and autonomously. Smart devices include but are not limited to smartphones, PCs, laptops, phablets and tablets, smartwatches, smart bands and smart key chains. A smart device can also refer to a ubiquitous computing device that exhibits some properties of ubiquitous computing including—although not necessarily—artificial intelligence. Smart devices can be designed to support a variety of form factors, a range of properties pertaining to ubiquitous computing and to be used in three primary system environments: physical world, human-centered environments, and distributed computing environments.

As used herein, the term “cloud” or phrase “cloud computing” means storing and accessing data and programs over the Internet instead of a computing device's hard drive. The cloud is a metaphor for the Internet.

Further, and as used herein, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, any kind of database object described herein can be implemented as single databases, a distributed database, a collection of distributed databases, a database with redundant online or offline backups or other redundancies, etc., and might include a distributed database or storage network and associated processing intelligence.

The computer system(s), computing device(s), method(s), computer program product(s) and the like, as described in the following example embodiments, may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means or the like. In general, any device(s) or means capable of implementing the methodology illustrated herein can be used to implement the various aspects of the example embodiments.

Computer program code for carrying out operations for aspects or embodiments of the present invention may be written in any combination of one or more programming languages, including a programming language such as JAVASCRIPT®, JAVA®, SQL™ PHP™, RUBY™, PYTHON®, JSON, HTML5™, OBJECTIVE-C®, SWIFT™, XCODE®, SMALLTALK™, C++ or the like, conventional procedural programming languages, such as the “C” programming language or similar programming languages, any other markup language, any other scripting language, such as VBScript, and many other programming languages as are well known may be used.

The program code may execute entirely on a user's computing device, partly on the user's computing device, as a stand-alone software package, partly on the user's computing device and partly on a remote computer or entirely on the remote computer or server. In the latter scenario, the remote computer may be connected to the user's computing device through any type of network, including a LAN or WAN, or the connection may be made to an external computer (for example, through the Internet using an Internet Service Provider).

Unless the context requires otherwise, throughout the specification and claims that follow, the word “comprise” and variations thereof, such as “comprises” and “comprising.” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

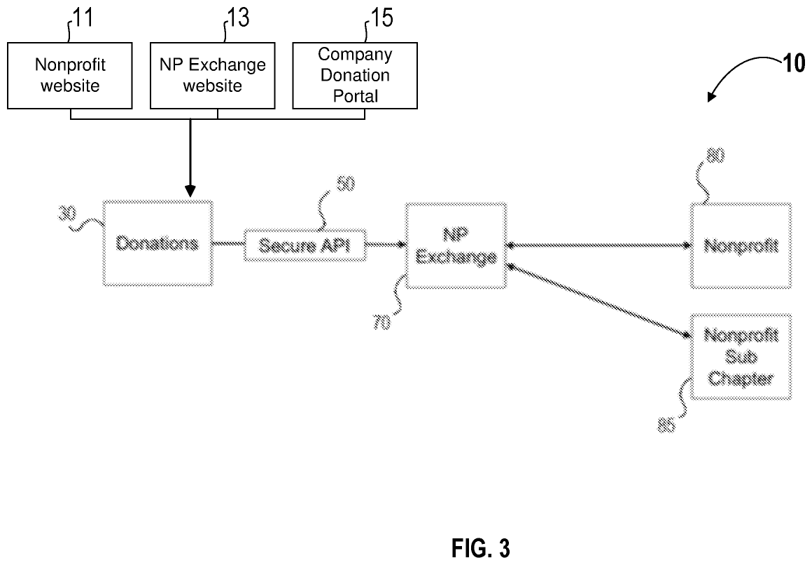

FIG. 3 is a general block diagram to illustrate the process flow for a method of performing digital asset donation transactions for nonprofit organizations, and the blockchain exchange system adapted to execute the method, according to the example embodiments. As shown in FIG. 3, an example blockchain-based nonprofit exchange system 10 for performing digital asset donation transactions includes a donation ingestion module 30 which may be part of a processor 720 of a computer system 700 on which sits the nonprofit (NP) exchange 70. Namely, various forms of digital asset donations are ingested at module 30 via a secure API 50 so as to be tokenized at NP exchange 70. Digital asset donations (ACH, wire, credit card, check/e-check, cryptocurrency, and/or securities) can be made through a registered NPO website, or directly through the web, or provided by an enterprise donation site of a company through API 50. Donations may be made from a registered nonprofit website 11, directly through the web to the NP Exchange website 13, and/or provided by a company donation portal 15 through secure API.

A stablecoin is a type of digital currency that avoids volatility. Before the term was even coined, a platform for stablecoins was created by Stellar, which is an open-source network for currencies and payments; e.g., creating, sending and trading digital representations of all forms of money—dollars, pesos, bitcoin, and the like. The software runs across a decentralized, open network and handles millions of transactions daily. Like Bitcoin and Ethereum, Stellar relies on blockchain to keep its network in sync. Stablecoins are tokens backed by fixed assets, like gold or fiat currency (government issued money such as the US Dollar). Because Stellar was designed for the express purpose of tokenizing fiat currencies, the issuance of stablecoins is a native feature of the network.

Accordingly, the example cloud-based, blockchain exchange system 10 described herein tokenizes donations using these stablecoins (denominated in USD) and eventually processes these donations for delivery to a nonprofit 80 or a subchapter 85 of the NPO. The blockchain NP exchange 70 provides the greatest level of security and accounting, and is PCI DSS Level 1 certified. Accordingly, donors can, through an appropriate web interface or API, make donations directly to registered. NPOs through any of the following digital asset forms: ACH, wire, credit card, check/e-check, cryptocurrency, and gift securities means. For those NPOs which cannot or do not wish to hold cryptocurrency assets, the NP exchange 70 provides instant settlement services. Moreover, the NP exchange 70 is configured so as to be able to readily accept securities gifting, where securities are liquidated upon receipt, the proceeds of which are transferred to the NPO 80.

Of note, NPOs 80 can transfer tokenized donations through the NP exchange 70 to other NPOs and associated subchapters 85. Like donations, the NP exchange 70 liquidates these tokenized assets for delivery to the specified NPO 80/subchapter 85. Nonprofits can transfer tokenized donations through the example system to other nonprofits or associated subchapters. The exchange liquidates donations to registered nonprofits/nonprofit subchapters via a clearinghouse.

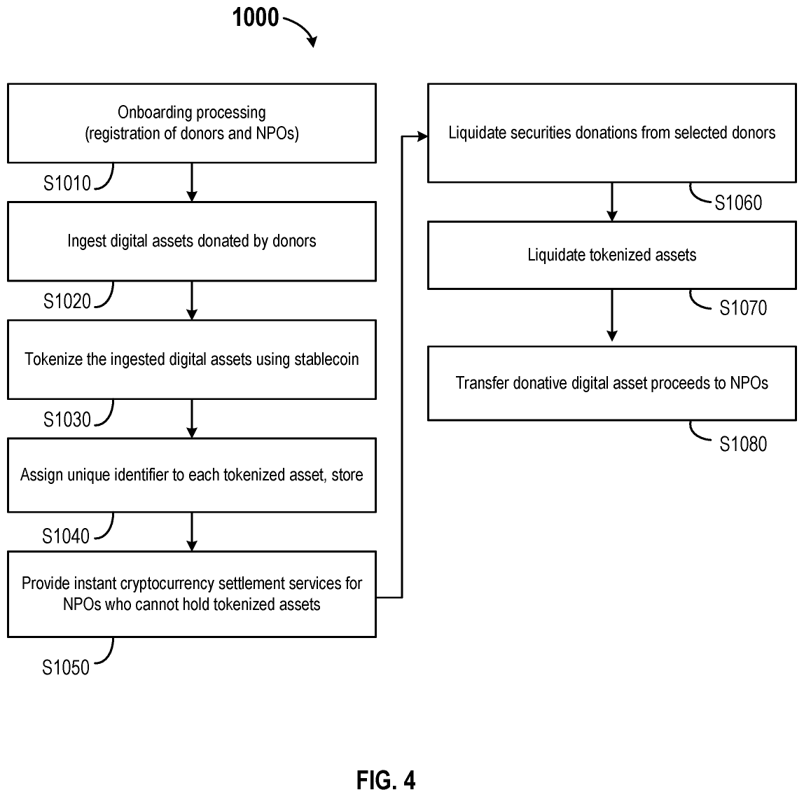

FIG. 4 is a flowchart to describe the method of performing digital asset donation transactions for nonprofit organizations in more detail, according to the example embodiments. Initially, in the method 1000 for performing digital asset donation transactions for nonprofit organizations, an onboarding process (step S1010) may be required to register NPOs and donors alike. The donation ingestion module 30 (of a processor 720 in a computer system/computing device 700 detailed hereafter, which iterates the function of method 1000 at NP exchange 70), then ingests (step S1020) selected digital asset donations of donors that are received through the secure API 50.

Payment APIs. API 50 is an application programming interface designed for managing payments. Payment APIs like API 50 enable eCommerce sites to process credit cards, track orders, and maintain customer lists. In many instances, APIs help protect merchants from fraud and information breaches, while also simplifying regulatory compliance. Payment APIs can integrate multiple payment sources and provide customers with a means of tracking their payments. Many of them permit managing recurring subscriptions. Similarly, they can also be used for maintaining lists of clients.

One example secure API adapted for use in the example embodiments is the STRIPE® payment API for online payments, which for developers gives access to methods for accepting payments, managing subscriptions, tracking user accounts, and sending invoices. But as bitcoin is the world's most widely used alternative currency (a currency medium not backed by any country's central bank or government) with a total market cap of over $100 billion, and with a bitcoin network made up of thousands of computers run by individuals all over the world, an alternative secure API is needed. Namely, example payments APIs which enable the acceptance of cryptocurrency payments (or “bitcoin”, digital currency using encryption techniques to regulate the generation of units of currency and verify the transfer of funds, operating independently of a central bank) include APIs offered by COINBASE® and COINIFY®.

COINIFY is an established global virtual currency platform which offers cryptocurrency solutions in Europe, Asia and other regions, including individual currency trading, corporate brokerage, payment processing services, and Enterprise solutions via COINIFY's Digital Currency API.

COINBASE is a digital currency wallet and platform where merchants and consumers can transact with digital currencies like bitcoin, ethereum, and litecoin, and is primarily used for tracking exchange rates, metadata, and payment methods. COINBASE provides a powerful REST API for digital currency to integrate bitcoin, bitcoin cash, Litecoin, and Ethereum payments into any business or application. Their API (“Coinbase API v2”) supports cross-origin HTTP requests commonly referred as CORS. This means that a developer can call API resources using JavaScript from any browser.

Referring again to FIG. 4, the ingested digital assets are then tokenized (step S1030) using stablecoin (denominated in USD). As previously discussed, stablecoin is a cryptocurrency for reducing volatility relative to some “stable” asset or basket of assets. A stablecoin can be pegged to a cryptocurrency, fiat money, or to exchange-traded commodities (such as precious metals or industrial metals). Each tokenized asset may be assigned a unique identifier for security and accounting, and is stored (step S1040).

Market Rate APIs. For those NPOs which cannot or do not wish to hold cryptocurrency assets, the NP exchange 70 provides instant settlement services (step S1050). Namely, cryptocurrency payments are instantly settled upon donation using the current cryptocurrency market rate. In addition to COINBASE, several other APIs may be applicable for tracking real-time cryptocurrency market rates, including but not limited to CRYPTOCOMPARE®, COINMARKETCAP®, and NOMICS®, each offering multiple tiers of service. Featuring 273 exchanges, the CRYPTOCOMPARE API offers the widest array of endpoints (e.g. endpoints returning data such as ordered cryptocurrency lists, or price and volume data, etc.). The CRYPTOCOMPARE API provides granular tick data and real-time update frequency and a high level of customer support with a dedicated slack channel for clients.

The COINMARKETCAP API is often a first port of call for many checking crypto-asset prices, and offers up to 22 endpoints as well as some partner integrations such as FCAS crypto ratings. Integrated with 319 exchanges, the COINMARKETCAP API is tailored for those looking to find data on smaller niche exchanges. The NOMICS API comes in two tiers, Free and Business (with no pricing featured on the site) and features 24-2 exchanges, with 17 endpoints. The API is a good choice for enterprise customers and traders with SLAB on offer, both REST and Websocket, granular tick data with real-time updates, and no rate limits.

Certain donations may be ingested as securities, such as major gift donations. NP exchange 70 has the processing capability of accepting securities and liquidating securities donations (step S1060). Accordingly, all forms of tokenized assets are thus liquidated by the NP exchange 70 (step S1070) with the donative proceeds transferred (step S1080) to the selected NPO 80/subchapter 85 through ACH,

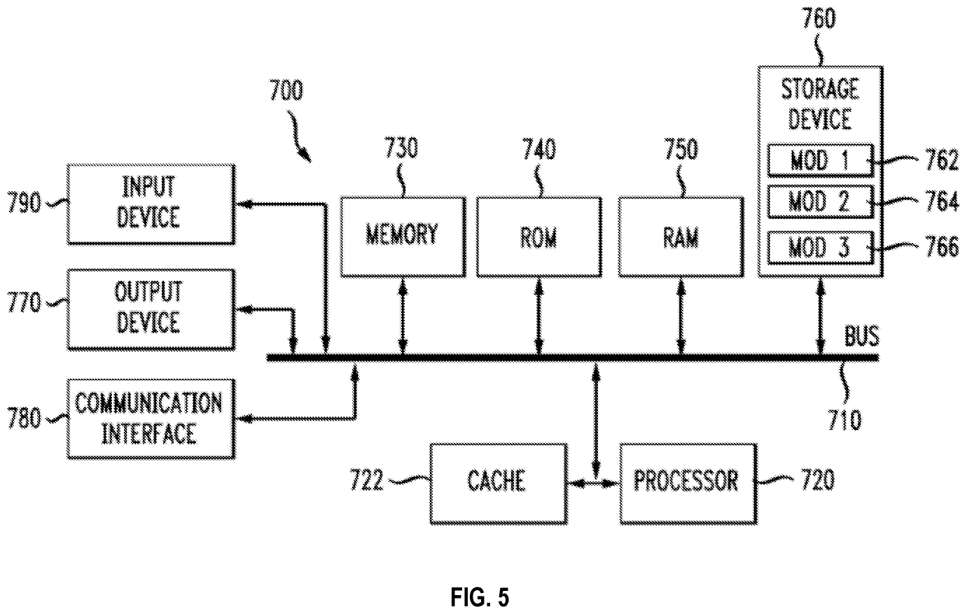

FIG. 5 is a block diagram of an exemplary computer system and/or computing device of the blockchain-based NP exchange 70 for implementing the example method, Namely, a description of a basic general-purpose computer system or computing device in FIG. 5 can be employed to practice the concepts, methods, and techniques disclosed. With reference to FIG. 5, an exemplary computer system and/or computing device 700 includes a processing unit (CPU or processor) 720 and a system bus 710 that couples various system components including the system memory 730 such as read only memory (ROM) 740 and random-access memory (RAM) 750 to the processor 720. The system 700 can include a cache 722 of high-speed memory connected directly with, in close proximity to, or integrated as part of the processor 720.

The system 700 copies data from the memory 730 and/or the storage device 760 to the cache 722 for quick access by the processor 720. In this way, the cache 722 provides a performance boost that avoids processor 720 delays while waiting for data. These and other modules can control or be configured to control the processor 720 to perform various operations or actions.

Other system memory 730 may be available for use as well. The memory 730 can include multiple different types of memory with different performance characteristics. It can be appreciated that the example blockchain-based nonprofit exchange 70 may operate on a computing device 700 with more than one processor 720 or on a group or cluster of computing devices networked together to provide greater processing capability.

The processor 720 can include any general-purpose processor and a hardware module or software module, such as module 1 762, module 2 764, and module 3 766 stored in storage device 760, configured to control the processor 720 as well as a special-purpose processor where software instructions are incorporated into the processor. The processor 720 may be a self-contained computing system, containing multiple cores or processors, a bus, memory controller, cache, etc. A multi-core processor may be symmetric or asymmetric. The processor 720 can include multiple processors, such as a system having multiple, physically separate processors in different sockets, or a system having multiple processor cores on a single physical chip.

Similarly, the processor 720 can include multiple distributed processors located in multiple separate computing devices, but working together such as via a communications network. Multiple processors or processor cores can share resources, such as memory 730 or the cache 722, or can operate using independent resources. The processor 720 can include one or more of a state machine, an application specific integrated circuit (ASIC), or a programmable gate array (PGA) including a field PGA.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up.

The computing device 700 further includes storage devices 760 or computer-readable storage media such as a hard disk drive, a magnetic disk drive, an optical disk drive, tape drive, solid-state drive, RAM drive, removable storage devices, redundant array of inexpensive disks (RAID), hybrid storage device, or the like. The storage device 760 can include software modules 762, 764, 766 for controlling the processor 720.

The system 700 can include other hardware or software modules. The storage device 760 is connected to the system bus 710 by a drive interface. The drives and associated computer-readable storage devices provide nonvolatile storage of computer-readable instructions, data structures, program modules and other data for the computing device 700. In one aspect, a hardware module that performs a particular function includes the software component stored in a tangible computer-readable storage device in connection with the necessary hardware components, such as the processor 720, bus 710, display 770, and so forth, to carry out a particular function. In another aspect, the system can use a processor and computer-readable storage device to store instructions which, when executed by the processor, cause the processor to perform operations, a method or other specific actions.

The basic components and appropriate variations can be modified depending on the type of device, such as whether the device 700 is a small, handheld computing device, a desktop computer, or a computer server. When the processor 720 executes instructions to perform “operations”, the processor 720 can perform the operations directly and/or facilitate, direct, or cooperate with another device or component to perform the operations.

Although the exemplary computer system 700 employs a hard disk 760, other types of computer-readable storage devices which can store data that are accessible by a computer, such as magnetic cassettes, flash memory cards, digital versatile disks (DVDs), cartridges, random access memories (RAMs) 750, read only memory (ROM) 740, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms. For example, a smart electronic device (smartphone, tablet, PDA and the like) can be accessed using an input device 790 such as a touch screen or pointing device (e.g., a mouse). Functions or outputs graphically shown on an output device 770 can be triggered by a user's finger where the input device 790 is a touch input, or with a cursor when the input device 790 is a mouse, or with the game player's eyes when the input device 216 is an eye tracker. Alternatively, functions or outputs of the system 700 graphically shown on a display can be triggered based on a user's facial or physical expression where the input device 790 is a camera with appropriate gesture tracking technology, with voice when the input device 790 is a microphone with appropriate voice recognition technology, or by thoughts when the input device 790 is a brain-computer interface.

The output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system 700 example is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general-purpose processor. For example the functions of one or more processors presented in FIG. 7 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 740 for storing software performing the operations described below, and random-access memory (RAM) 750 for storing results. Very large-scale integration (VLSI) hardware examples, as well as custom VLSI circuitry in combination with a general-purpose DSP circuit, may also be provided.

The logical operations of the various examples are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 5 can practice all or part of the recited method(s), can be a part of the recited blockchain-based nonprofit exchange 70, and/or can operate according to instructions in the recited tangible computer-readable storage devices. Such logical operations can be implemented as modules configured to control the processor 720 to perform particular functions according to the programming of the module. For example, FIG. 5 illustrates three modules Mod1 762, Mod2 764 and Mod3 766 which are modules configured to control the processor 720. These modules may be stored on the storage device 760 and loaded into RAM 750 or memory 730 at runtime or may be stored in other computer-readable memory locations.

One or more parts of the example computer system or computing device 700, up to and including the entire computing device 700, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 720 can include all types of processors disclosed herein, including a virtual processor. However, when referring to a virtual processor, the processor 720 includes the software components associated with executing the virtual processor in a virtualization layer and underlying hardware necessary to execute the virtualization layer. The system 700 can include a physical or virtual processor 720 that receive instructions stored in a computer-readable storage device, which cause the processor 720 to perform certain operations. When referring to a virtual processor 720, the system also includes the underlying physical hardware executing the virtual processor 720.

Further, the system 700 of FIG. 5 can also represent a virtual reality device. The device can be a headset that is entirely contained or can include a headset that receives a mobile device such as a Samsung device or an iPhone or other mobile device. In this regard, the features of FIG. 5 can include the components of such a headset. The input device 790 can represent one or more different types of input devices, such as a camera for taking still images or video, a fingerprint reader which can be configured on a side of the headset for easy confirmation of purchases by a user, while in a virtual reality environment. The output device 770 can represent a screen through which the user views images. A communication interface 780 can provide a Wi-Fi, or cellular or other wireless communication means with other devices, access points, base stations, and so forth. The adjudication interface 780 may also represent an interface between a removable mobile device and the headset for communicating data between the two components. Memory 730 can represent any standard memory used in the art as well as a secure element which can be used to store payment information and/or other user information in a secure manner for use in payment processes such as Apple Pay.

Accordingly, system 10 provides the greatest level of security and accounting, as it has a security rating of PCI/DSS Level 1. System 10 provides a web interface by which individual donors can make donations directly to registered nonprofits through credit card, e-check, and/or cryptocurrency payments. Since non-profits may not want to hold cryptocurrency assets, the system further provides for cryptocurrency-based instant settlement services.

Moreover, system 10 and the process it iterates as shown in FIG. 4 is able to make the stablecoin traceable. Namely, as the NP Exchange 70 sits on a distributed ledger network, and once the ingested digital assets are tokenized using stablecoins, the movement of all of these tokens are tracked, and payouts are made to provide full transparency. Using blockchain transaction verification capabilities, the NP Exchange 70 of system 10 can have one or more independent organization(s) validate all transactions. Thus, system 10 offers the ability to trace stablecoins so as to ensure transparency and concurrently is able to exploit its blockchain to backstop the tokenizing of those donations using stablecoin so as to effect payment to NPOs, charities, and the like.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The example method and blockchain-based nonprofit exchange having been described herein may offer significant advantages and benefits not available with conventional blockchain systems. For example, the nonprofit exchange provides diversity of payment options (credit card, e-check, cryptocurrency, and securities donations), effectively increasing the donor pool. Additionally, the nonprofit exchange provides a single-point donation processing solution, eliminating the complexity and cost of maintaining several credit card, e-check, cryptocurrency, and major gift processing vendor relationships. This in turn may lower NPO administration costs and direct fees while increasing flexibility for the donor, resulting in more money for the NPO's mission.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A method executed by one or more computing devices for performing digital asset donation transactions for nonprofit organizations (NPOs), comprising:
ingesting, by at least one of the one or more computing devices, digital donation assets from one or more donors intended for a NPO,
tokenizing, by at least one of the one or more computing devices, the ingested digital donation assets to provide tokenized assets, and
processing the tokenized assets for transfer via automated clearinghouse (ACH) to the NPO, wherein the ingesting, tokenizing, and processing steps are performed by computer software adapted to run on computer hardware of the one or more computing devices.

2. The method of claim 1, where the ingested digital donation assets are selected from the group consisting of ACH assets, wire payments, checks, e-checks, credit cards, cryptocurrency, and gifted securities.

3. The method of claim 1, wherein the tokenized assets are stablecoin backed by gold or fiat currency.

4. The method of claim 1, further comprising:
providing instant settlement services for any NPO which cannot or does not wish to hold cryptocurrency assets.

5. The method of claim 4, wherein instant settlement services are provided such that a cryptocurrency payment is settled upon donation using a cryptocurrency market rate tracked by a market rate API.

6. The method of claim 1, wherein the one or more computing devices are further configured to enable an NPO to transfer any of its tokenized assets to other NPOs and subchapters associated with those NPOs.

7. The method of claim 1, wherein ingesting digital donation assets further includes accessing the digital donation assets via a secure application programming interface (API) from at least one of a registered NPO website, a website of a nonprofit exchange computing device which tokenizes the accessed donation assets and processes the tokenized assets for transfer, and an enterprise donation portal of a company.

8. The method of claim 1, wherein ingesting digital donation assets further includes a payment API configured to accept a cryptocurrency donation asset using encryption techniques that regulate the generation of units of currency and verify the transfer thereof, the API operating independently of a central bank.

9. A computer system adapted for performing digital asset donation transactions for nonprofit organizations (NPOs), comprising
a processing hardware set, and
a computer-readable storage device medium, wherein the processing hardware set is structured, connected and/or programmed to run program instructions stored on the computer-readable storage medium instructions and associated data, the program instructions including:
an ingestion module programmed to ingest digital donation assets from one or more donors intended for a NPO,
a tokenization module programmed to tokenize the ingested digital donation assets to provide tokenized assets,
a database for storing unique identifiers associated with the tokenized assets, and
a processing module programmed to process the tokenized assets for transfer via automated clearinghouse (ACH) to the NPO.

10. The computer system of claim 9, where the digital donation assets are selected from the group consisting of ACH assets, wire payments, checks, e-checks, credit cards, cryptocurrency assets, and gifted securities.

11. The computer system of claim 9, wherein the tokenized assets are stablecoin backed by gold or fiat currency.

12. The computer system of claim 9, wherein the processing module is further programmed to provide instant settlement services for any NPO which cannot or does not wish to hold digital donation assets which are cryptocurrency assets.

13. The computer system of claim 12, wherein the instant settlement services are provided such that a cryptocurrency payment is settled upon donation using a cryptocurrency market rate tracked by a market rate API.

14. The computer system of claim 9, wherein the processing module is further programmed to enable an NPO to transfer any of its tokenized assets to other NPOs and subchapters associated with those NPOs.

15. The computer system of claim 9, wherein the ingestion module is further programmed to access digital donation assets via a secure application programming interface (API) from at least one of a registered NPO website, a website of a nonprofit exchange computing device which tokenizes the accessed donation assets and processes the tokenized assets for transfer, and an enterprise donation portal of a company.

16. The computer system of claim 9, wherein the ingestion module is composed of a payment API configured to accept a cryptocurrency donation asset using encryption techniques that regulate the generation of units of currency and verify the transfer thereof, the API operating independently of a central bank.

17. A computer system adapted for performing digital asset donation transactions for nonprofit organizations (NPOs), comprising
a processing hardware set, and
a computer-readable storage device medium, wherein the processing hardware set is structured, connected and/or programmed to run program instructions stored on the computer-readable storage medium instructions and associated data, the program instructions including:
a payment API configured to accept a cryptocurrency donation asset using encryption techniques that regulate the generation of units of currency and verify the transfer thereof, the API operating independently of a central bank,
a tokenization module programmed to tokenize the cryptocurrency donation asset using stablecoin to provide tokenized assets,
a database for storing unique identifiers associated with the tokenized assets, and
a processing module programmed to process the tokenized assets for transfer to the NPO.

18. The computer system of claim 17, wherein the processing module is further programmed to enable an NPO to transfer any of its tokenized assets to other NPOs and subchapters associated with those NPOs.

19. The computer system of claim 17, wherein the processing module is further programmed to provide instant settlement services for any NPO which cannot or does not wish to hold digital donation assets which are cryptocurrency assets.

20. The computer system of claim 19, wherein the instant settlement services are provided such that a cryptocurrency payment is settled upon donation using a cryptocurrency market rate tracked by a market rate API.
